(19) United States
(12) Patent Application Publication
(10) Pub. No.: US 2010/0327044 A1
(43) Pub. Date: Dec. 30, 2010

(54) METHOD FOR MANUFACTURING ELECTRONIC COMPONENT MODULE

(75) Inventors: Tadahiko Sakai, Fukuoka (JP); Koji Motomura, Fukuoka (JP); Hideki Eifuku, Fukuoka (JP)

Correspondence Address: RATNERPRESTIA, P.O. BOX 980, VALLEY FORGE, PA, 19482, US

(73) Assignee: Panasonic Corporation

(21) Appl. No.: 12/866,911

(22) PCT Filed: Feb. 18, 2009
(86) PCT No.: PCT/JP2009/000651

§ 371 Date: Aug. 10, 2010

(30) Foreign Application Priority Data
Feb. 25, 2008 (JP) 2008-042462

(51) Int. Cl. B23K 31/02

(52) U.S. Cl. 228/175

(57) ABSTRACT

After disposing bonding material including thermosetting resin containing solder particles in a region that covers at least land part on an upper surface of base wiring layer and holding electronic component by base wiring layer by positioning terminal part with respect to land part and adhesively bonding at least terminal part to bonding material that covers at least land part, bonding material is semi-cured by heating. Therefore, warp deformation of the base wiring layer can be suppressed and bonding reliability can be secured.

### TECHNICAL FIELD

The present invention relates to a method for manufacturing an electronic component module, which manufactures an electronic component module having a configuration in which electronic components are installed on a base wiring layer provided with a wiring pattern, and the electronic components and the wiring pattern are sealed by a sealing resin layer.

### BACKGROUND ART

Electronic components such as a semiconductor element are usually incorporated in an electronic device in the form of an electronic component module in which electronic components mounted on a base wiring layer such as a resin substrate are sealed by resin. With a trend toward the high mounting density in an electronic component module, a form of the so-called component built-in substrate is being employed as the electronic component module in which the electronic components are mounted on inner layers of a plurality of laminated electrode patterns (see, for example, Patent Document 1). In Patent Document 1, prepregs as thermosetting sheets for forming a sealing resin layer and the plurality of electrode patterns are sequentially laminated, so that the electronic component is embedded in the inner layer.

Recently, increasing demands for small size and high function of portable electronic devices require a further increase in the mounting density in the electronic component module in the form of the above-mentioned component built-in substrate. Therefore, a resin substrate to be used as a base wiring layer in the component built-in type electronic component module is being thinned. However, the use of such a thin resin substrate as the base wiring layer poses the following problems.

When electronic components are mounted on a base wiring layer such as a resin substrate, steps including heating, for example, solder bonding, thermo-compression bonding, and the like, are essential. Therefore, warp deformation due to heat in low-rigidity thin resin substrates is inevitable. In particular, when components are mounted in a plurality of separate mounting processes depending upon the types of components, warp deformation that occurs in the first mounting process tends to cause mounting problems such as displacement of components and connection failure in the subsequent mounting processes.

When a thermosetting sheet for forming a resin sealing layer is laminated on a base wiring layer on which components are mounted in a state in which such mounting problems remain, pressurization and heating are carried out in a state in which components are displaced in the laminating step. This may cause critical problems such as damage in a component and breakage in a solder bonding part. Thus, in a conventional method for manufacturing an electronic component module, in a step of laminating a thermosetting sheet for forming a sealing resin layer, problems caused by warp deformation of the base wiring layer, which occur when components are mounted, tend to occur. As a result, it has been difficult to secure bonding reliability.

Patent document 1: International Publication WO 2005/004567

### SUMMARY OF THE INVENTION

The present invention provides a method for manufacturing an electronic component module in which warp deformation of a base wiring layer can be suppressed and bonding reliability can be secured.

The present invention provides a method for manufacturing an electronic component module. The electronic component module includes a base wiring layer having, on an upper surface thereof, a wiring pattern including a land part to which an electronic component is to be connected; an electronic component including a main body part and a terminal part, the electronic component being installed on the base wiring layer in a state in which the terminal part is connected to the land part; and a sealing resin layer that is formed in close contact with the upper surface of the base wiring layer and the main body part and seals the electronic component and the wiring pattern to each other. The method includes: disposing a bonding material made of thermosetting resin containing solder particles in a region that covers at least the land part on the upper surface of the base wiring layer; positioning the terminal part with respect to the land part and adhesively bonding at least the terminal part to the bonding material that covers the land part, thereby holding the electronic component by the base wiring layer; after the holding of the electronic component, semi-curing the bonding material by heating; and after the semi-curing of the bonding material, thermo-compression bonding a thermosetting sheet for forming the sealing resin layer in a state in which the thermosetting sheet is attached to an upper surface of the base wiring layer, thereby curing the thermosetting sheet, curing the bonding material, and solder-boding the terminal part to the land part.

Such a configuration includes steps of disposing a bonding material including thermosetting resin containing solder particles on the surface of the base wiring layer, adhesively bonding electronic components to the bonding material, and heating and semi-curing the bonding material to which the electronic components are adhesively bonded. Thus, warp deformation of the base wiring layer can be suppressed, so that problems in the laminating step can be excluded and bonding reliability can be secured.

### BRIEF DESCRIPTION OF THE DRAWINGS

FIG. 1A is a view to illustrate a first step showing a method for manufacturing an electronic component module in accordance with one exemplary embodiment of the present invention.

FIG. 1B is a view to illustrate a first step showing a method for manufacturing an electronic component module in accordance with one exemplary embodiment of the present invention.

FIG. 1C is a view to illustrate a first step showing a method for manufacturing an electronic component module in accordance with one exemplary embodiment of the present invention.

FIG. 1D is a view to illustrate a first step showing a method for manufacturing an electronic component module in accordance with one exemplary embodiment of the present invention.

FIG. 1E is a view to illustrate a first step showing a method for manufacturing an electronic component module in accordance with one exemplary embodiment of the present invention.

FIG. 1F is a view to illustrate a first step showing a method for manufacturing an electronic component module in accordance with one exemplary embodiment of the present invention.

FIG. 1G is a view to illustrate a first step showing a method for manufacturing an electronic component module in accordance with one exemplary embodiment of the present invention.

FIG. 1H is a view to illustrate a first step showing a method for manufacturing an electronic component module in accordance with one exemplary embodiment of the present invention.

FIG. 2 is a view to illustrate warp deformation of the base wiring layer in a method for manufacturing an electronic component module in accordance with one exemplary embodiment of the present invention.

FIG. 3A is a view to illustrate a second step showing a method for manufacturing an electronic component module in accordance with one exemplary embodiment of the present invention.

FIG. 3B is a view to illustrate a second step showing a method for manufacturing an electronic component module in accordance with one exemplary embodiment of the present invention.

FIG. 3C is a view to illustrate a second step showing a method for manufacturing an electronic component module in accordance with one exemplary embodiment of the present invention.

### REFERENCE MARKS IN THE DRAWINGS

1 base wiring layer
2 resin substrate
3, 4 wiring pattern
3a, 3b land part
5 first bonding material
5a, 7a solder particles
5b, 7b thermosetting resin
5c, 7c solder bonding part
5d, 7d resin part
6 first electronic component
6a, 8a main body part
6b terminal part
7 second bonding material
8 second electronic component
8b metal bump
10, 12, 15 prepreg
10a opening
10b sealing resin layer
11, 14 wiring layer
13, 16 copper foil
17 laminated body
17a through hole
18 interlayer wiring part
19 electronic component module

### DETAILED DESCRIPTION OF THE PREFERRED EMBODIMENT

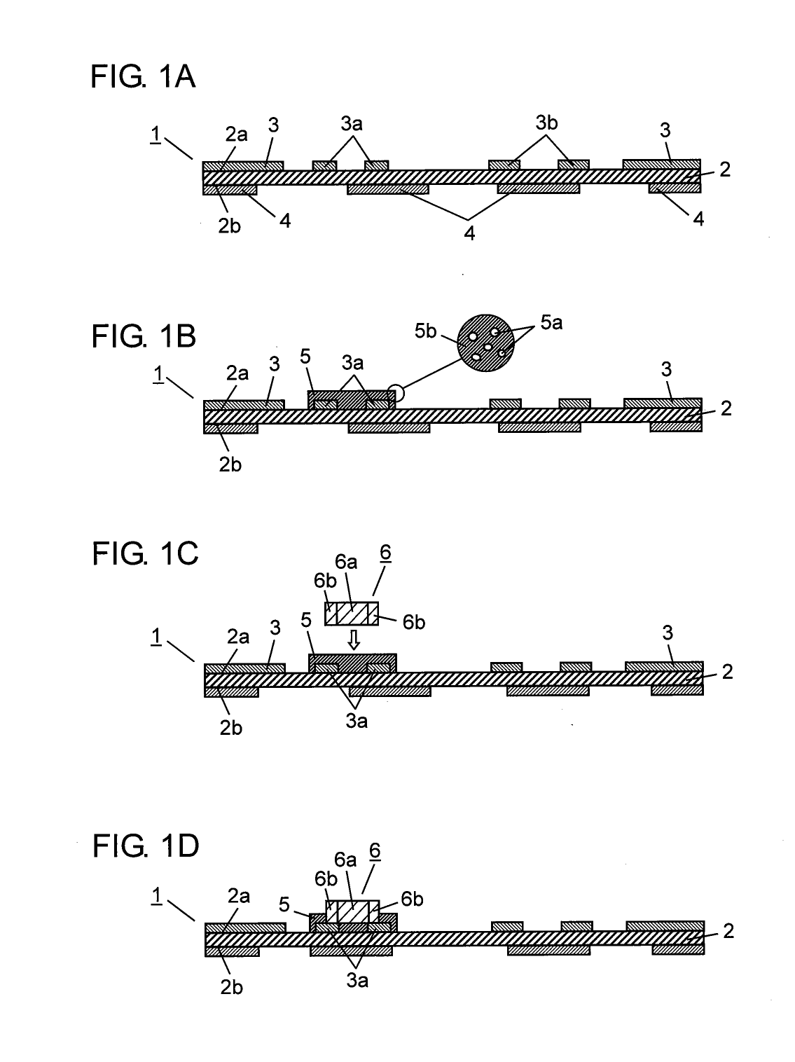

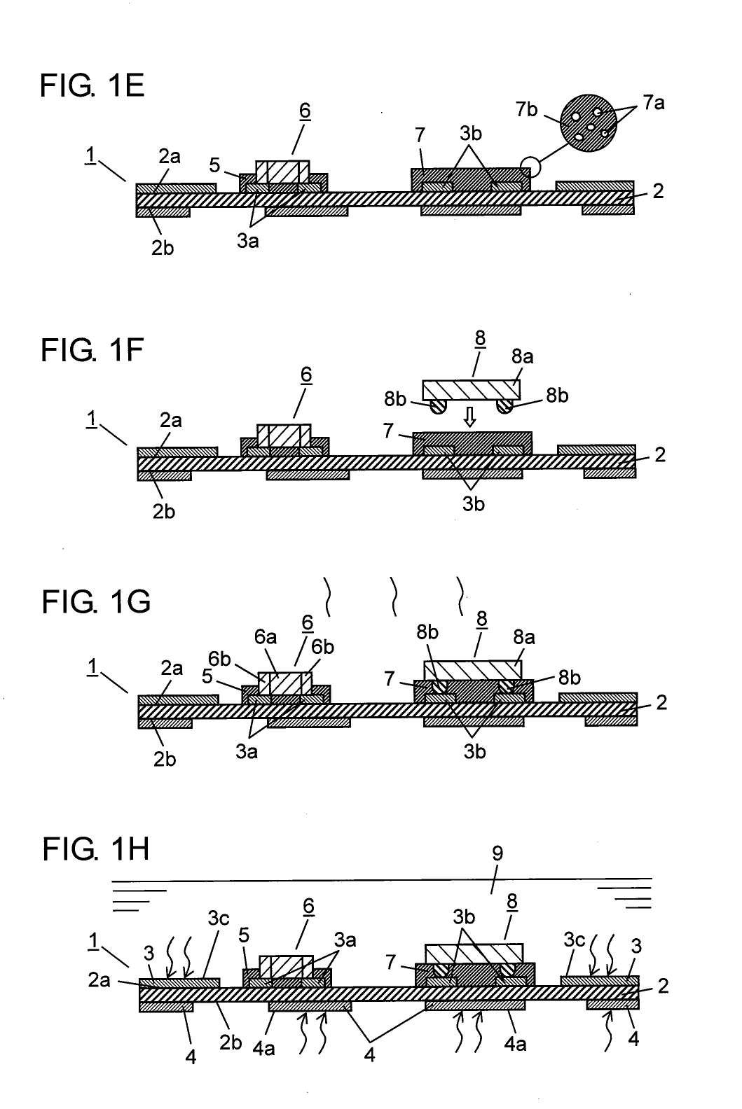

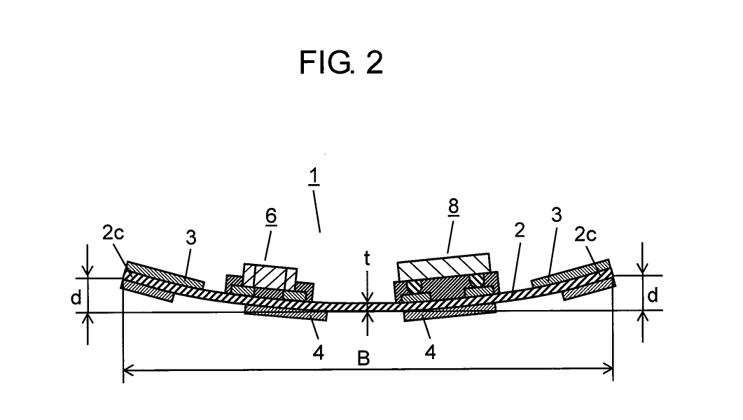

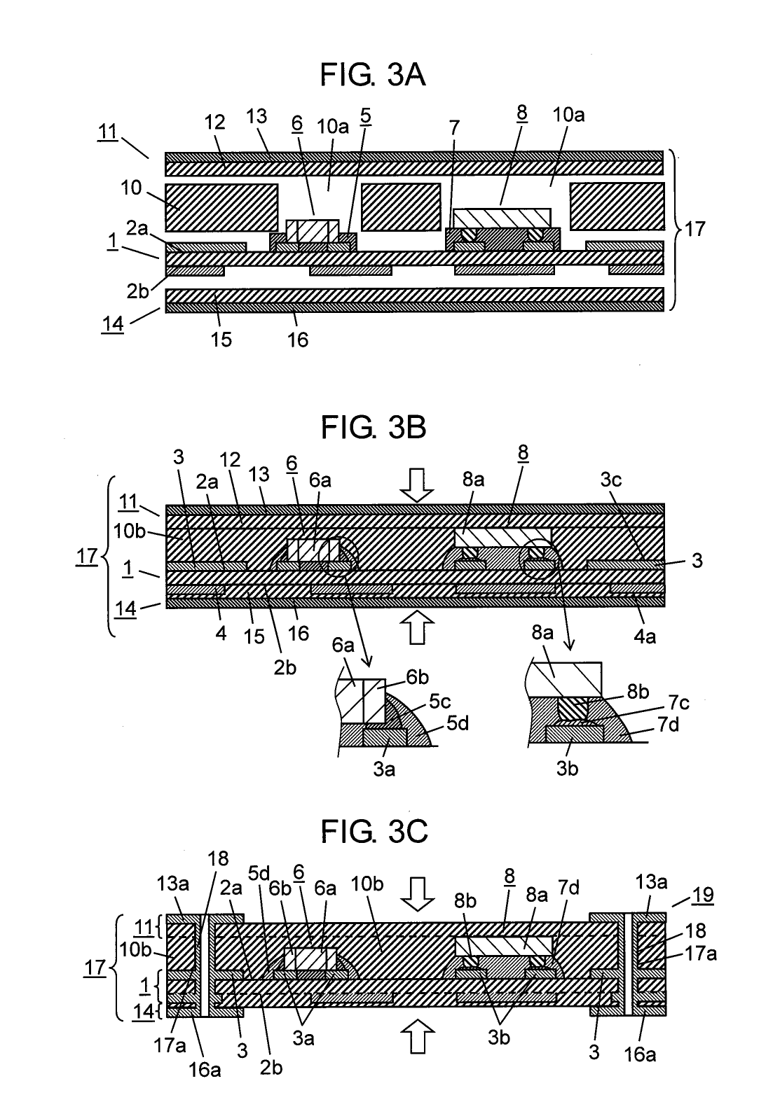

Hereinafter, exemplary embodiments of the present invention are described with reference to drawings. FIGS. 1A to 1H are views to illustrate a first step showing a method for manufacturing an electronic component module in accordance with one exemplary embodiment of the present invention. FIG. 2 is a view to illustrate warp deformation of a base wiring layer in a method for manufacturing an electronic component module in accordance with one exemplary embodiment of the present invention. FIGS. 3A to 3C are views to illustrate a second step showing a method for manufacturing an electronic component module in accordance with one exemplary embodiment of the present invention.

FIG. 1A shows base wiring layer 1 having a configuration in which wiring patterns 3 and 4 are formed on upper surface 2a and lower surface 2b of insulating resin substrate 2, respectively. A part of wiring patterns 3 serves as land parts 3a and 3b to which terminals of electronic components are to be connected. That is to say, base wiring layer 1 has wiring pattern 3 on upper surface 2a, and wiring pattern 3 includes land parts 3a and 3b to which electronic components are to be connected. To land parts 3a, a first electronic component having terminals for connection on both end portions thereof is mounted. An example of the first electronic component includes a chip-type small component such as a resistor and a capacitor. To land parts 3b, a second electronic component having metal bumps as terminal parts for connection on the bottom surface thereof is mounted. An example of the second electronic component includes a semiconductor chip. The metal bump may be formed of solder or may be formed of metal other than solder. In any case, materials whose melting point temperature is higher than a heating temperature in the below-mentioned pressing step are used.

Next, as shown in FIG. 1B, first bonding material 5 is disposed in a region that covers at least the surfaces of land parts 3a on the surface (upper surface 2a) of base wiring layer 1 (first bonding material disposing step). First bonding material 5 includes thermosetting resin 5b having an activating function for removing a solder oxide film and containing solder particles 5a as shown in an enlarged view in a circle. Herein, first bonding material 5 is disposed not only in the region that covers the surfaces of land parts 3a but also in the region corresponding to main body part 6a of the below-mentioned first electronic component 6 (portions between two land parts 3a in the drawing). As solder particles 5a, for example, solder particles having a composition of SnBi58 and a melting point temperature of about 139° C. are used. As thermosetting resin 5b, for example, epoxy resin, acrylate resin, polyimide, polyurethane and phenol resin, and unsaturated polyester resin are used. First bonding material 5 is disposed on the surface of base wiring layer 1 by a method such as a screen printing, an application by a dispenser, and a method of attaching a resin film that has been formed in a film shape. Various methods can be selected in accordance with shapes and regions of materials to be disposed.

Thereafter, as shown in FIG. 1C, to base wiring layer 1 in which first bonding material 5 is disposed on land part 3a, chip-type first electronic component 6 including main body part 6a and terminal parts 6b provided on both end portions of main body part 6a is placed. Herein, terminal parts 6b of first electronic component 6 are positioned to land parts 3a, and at least terminal parts 6b are adhesively bonded to first bonding material 5 that covers the surface of land part 3a. Thereby, first electronic component 6 is held by base wiring layer 1 (first electronic component holding step). Thus, first electronic component 6 is held by base wiring layer 1 via adhesive first bonding material 5. At this time, in this exemplary embodiment, as shown in FIG. 1D, on the upper surface of base wiring layer 1, first bonding material 5 is disposed not only on a portion that covers land part 3a but also in a region corresponding to main body part 6a of first electronic component 6. Thus, first electronic component 6 is in a state in which not only terminal part 6b but also main body part 6a is adhesively bonded to bonding material 5, so that first electronic component 6 is held by base wiring layer 1 via bonding material 5 with sufficient fixing power.

Next, as shown in FIG. 1E, second bonding material 7 is disposed in a region that covers at least the surfaces of land parts 3b on the surface (upper surface 2a) of base wiring layer 1 (second bonding material disposing step). Herein, second bonding material 7 is disposed not only in the region that covers the surfaces of land parts 3b but also in the region corresponding to main body part 8a of second electronic component 8 mentioned below (portions between two land parts 3b in the drawing). Similar to first bonding material 5, second bonding material 7 has a composition including thermosetting resin 7b having an activating function for removing a solder oxide film and containing solder particles 7a as shown in an enlarged view in a circle. As second bonding material 7, materials having the same composition as that of first bonding material 5 are used. As second bonding material 7, a material having a different composition from that of first bonding material 5 may be used depending upon the properties of second electronic component 8. When first bonding material 5 and second bonding material 7 are formed of materials having the same composition, the same bonding material can be disposed on land parts 3a and 3b at one time in the same bonding material disposing step.

Thereafter, as shown in FIG. 1F, to base wiring layer 1 in which second bonding material 7 is disposed on land parts 3b, second electronic component 8 having metal bumps 8b formed of solder on the lower surface of main body part 8a is placed. Herein, metal bumps 8b of second electronic component 8 are positioned to land parts 3b, and at least metal bumps 8b are adhesively bonded to bonding material 7 that covers the surface of land parts 3b. Thereby, second electronic component 8 is held by base wiring layer 1 (second electronic component holding step). Thus, second electronic component 8 is held by base wiring layer 1 via adhesive second bonding material 7. At this time, according to this exemplary embodiment, on upper surface 2a of base wiring layer 1, second bonding material 7 is disposed not only on a portion that covers land parts 3b but also in a region corresponding to main body part 8a of first electronic component 8. Thus, second electronic component 8 is in a state in which not only metal bump 8b but also main body part 8a is adhesively bonded to second bonding material 7, so that second electronic component 8 is held by base wiring layer 1 via second bonding material 7 with sufficient fixing power. Note here that metal bumps 8b correspond to the terminal parts of second electronic component 8.

Then, base wiring layer 1 on which first electronic component 6 and second electronic component 8 are placed is transferred to a curing device and heated as shown in FIG. 1G. Thus, both first bonding material 5 and second bonding material 7 are heated, and the thermosetting reactions of thermosetting resins 5b and 7b proceed. At this time, thermosetting resins 5b and 7b are not completely cured by heat control, and the thermosetting reaction is stopped halfway so as to make a semi-cured state. That is to say, herein, first bonding material 5 and second bonding material 7 after electronic component holding steps shown in FIG. 1C and FIG. 1F are carried out are heated and semi-cured (bonding material temporary curing step).

In the bonding material temporary curing step, the purpose of promoting the thermosetting reactions of thermosetting resins 5b and 7b is to increase adhesive strength by first bonding material 5 and second bonding material 7 and to allow base wiring layer 1 to hold first electronic component 6 and second electronic component 8 in a stable manner. Herein, in order to promote the thermosetting reactions of thermosetting resins 5b and 7b so as to increase the holding force of first electronic component 6 and second electronic component 8, it is desirable to employ heating conditions in which higher heating temperature and longer heating time are secured. However, such a heating condition of heating at high temperature and for long heating time is applied to base wiring layer 1 mainly including thin resin substrate 2, warp deformation occurs in base wiring layer 1 due to heating.

That is to say, in base wiring layer 1 in a state in which wiring patterns 3 and 4 are laminated on low-rigidity thin resin substrate 2, and first electronic component 6 and second electronic component 8 are further placed thereon, complex thermal displacement occurs due to the difference in the coefficient of thermal expansion in each part. As a result, base wiring layer 1 is deformed in a form of warp or bending. For example, FIG. 2 shows an example of “upward warp” in which both end portions 2c of resin substrate 2 constituting base wiring layer 1 are deformed so that they are lifted up by thermal deformation. The “upward warp” is the most common and simplest deformation form. The degree of deformation in this case is represented by the ratio (d/B) of displacement amount d of both end portions 2c to width dimension B of the subject base wiring layer 1. Such warp deformation of base wiring layer 1 is required to be reduced as much as possible because it is a cause for inducing problems such as connection failure when other wiring layers are laminated on base wiring layer 1 in the subsequent steps in the process for manufacturing an electronic component module.

Therefore, in the method for manufacturing an electronic component module in accordance with this exemplary embodiment, in the above-mentioned bonding material temporary curing step shown in FIG. 1G, first bonding material 5 and second bonding material 7 are semi-cured in the heating conditions in which warp deformation due to heating of base wiring layer 1 is not more than a predetermined permissible amount. Specifically, the heating conditions are set so that the deformation amount represented by the ratio (d/B) of displacement amount d of both end portions 2c to width dimension B of base wiring layer 1 is made to be not more than 0.2, which is a permissible deformation amount preset as a degree of deformation that does not induce failure in the subsequent steps.

The heating conditions for the bonding material temporary curing step are preferably determined by considering a variety of conditions, for example, conditions with respect to materials and thickness of the base wiring layer, conditions with respect to materials, physical properties and thickness of the bonding material, conditions with respect to dimension, number, and placement density of an electronic component to be placed on the base wiring layer, and the like. In this exemplary embodiment, when these things are taken into consideration, the deformation amount represented by the ratio (d/B) of displacement amount d of both end portions 2c to width dimension B is set to not more than 0.2, no failure was induced in the subsequent steps. Furthermore, when warp does not occur due to the heating in the bonding material temporary curing step, the permissible deformation amount satisfies d/B=0.

That is to say, the subject base wiring layer 1 is provided. A variety of heating conditions are applied to the subject base wiring layer 1 so that actual thermal deformation occurs. Thereby, the relation between the heating condition and the deformation amount is demonstratively obtained as thermal deformation data. From the thermal deformation data and the above-mentioned permissible deformation amount, more specific heating condition is set. Herein, base wiring layer 1 having a rectangular shape, thickness t of resin substrate 2 of 0.05 mm to 1.00 mm, and width dimension B×length dimension (dimension in the direction perpendicular to width dimension B in the rectangular shape) of 330 mm×250 mm to 500 mm×600 mm is employed as the subject.

The purpose of the bonding material temporary curing step is to promote the thermosetting reactions of thermosetting resin 5b and thermosetting resin 7b in the range in which the warp deformation of base wiring layer 1 does not induce failure in the subsequent steps as mentioned above. Therefore, solder particles 5a and 7a contained in first bonding material 5 and second bonding material 7 may be melted or may not be melted in the bonding material temporary curing step. However, from the viewpoint of minimizing warp deformation in the bonding material temporary curing step, it is desirable that the heating temperature is as low as possible. Thus, in the bonding material temporary curing step, it is desirable that the heating condition is set so that first bonding material 5 and second bonding material 7 are heated to a temperature that is not higher than the melting point temperatures of solder particles 5a and 7a.

Thereafter, base wiring layer 1 after the bonding material temporary curing step shown in FIG. 1G is subjected to treatment for roughening a surface of the wiring pattern (roughening treatment step). That is to say, as shown in FIG. 1H, base wiring layer 1 is immersed in processing solution 9 such as a strong acid solution. Thus, surface 3c of wiring pattern 3 and surface 4a of wiring pattern 4 are roughened by oxidation. Then, on the surfaces, anchor patterns including minute concave and convex portions are formed. At this time, land parts 3a and 3b are covered with and protected by first bonding material 5 and second bonding material 7, which are thermally cured to some extend and become in a gel state. Thus, land part 3a and land part 3b are not affected by the roughening treatment and they are kept in a sound state. At the same time, first electronic component 6 and second electronic component 8 are kept in a state in which they are held by base wiring layer 1 with first bonding material 5 or second bonding material 7.

Thereafter, base wiring layer 1 is transferred to a pressing step. In the pressing step, a prepreg as a thermosetting sheet for forming a sealing resin layer that seals first electronic component 6, second electronic component 8 and wiring patterns 3 on the periphery thereof is laminated on upper surface 2a of resin substrate 2 constituting base wiring layer 1. Furthermore, a plurality of wiring layers are laminated on the upper surface of the prepreg, and subjected to thermo-compression bonding by a pressing device equipped with a heating device. Herein, the sealing resin layer is formed in close contact with upper surface 2a of resin substrate 2, main body part 6a of first electronic component 6, and main body part 8a of second electronic component 8, and surrounds and fixes first electronic component 6 and second electronic component 8 from the periphery.

Firstly, as shown in FIG. 3A, prepreg 10 having openings 10a corresponding to the positions of first electronic component 6 and second electronic component 8 is laminated on the upper surface 2a side of base wiring layer 1. Furthermore, wiring layer 11 formed by attaching copper foil 13 to the upper surface side of prepreg 12 is laminated on prepreg 10. Furthermore, wiring layer 14 formed by attaching copper foil 16 to the lower surface side of prepreg 15 is laminated on the lower surface side of base wiring layer 1.

Next, as shown in FIG. 3B, laminated body 17 composed of wiring layer 14, base wiring layer 1, prepreg 10 and wiring layer 11 is pressurized under a pressure of about 30 kg/cm² by the use of a pressing device in the direction shown by an arrow and heated at a temperature of about 150° C. to 200° C. The heating temperature at this time is set so as to be higher than the melting point temperature of solder particles 5a and 7a of first and second bonding materials 5 and 8 and lower than the melting point temperature of metal bump 8b provided on second electronic component 8. Resin with which each layer of prepreg 12, 10 and 15 is impregnated is once softened and the neighboring interfaces are fused to each other. Thus, prepreg 10 and prepreg 15 are brought into close contact with surfaces 3c and 4a of wiring patterns 3 and 4, respectively. At this time, an excellent adhesive property can be secured because minute anchor patterns are formed on the surfaces of surfaces 3c and 4a in the roughening treatment step.

Furthermore, resin with which the prepreg 12 and 10 is impregnated is pressurized and heated so as to fill a gap portion in opening 10a and is brought into close contact with first electronic component 6 and second electronic component 8. Then, with further heating, first electronic component 6, first bonding material 5, second electronic component 8, and second bonding material 7 are heated. The heating temperature at this time is set to be higher than the melting point temperatures of solder particles 5a and 7a contained in first bonding material 5 and second bonding material 7 and lower than the melting point temperature of metal bump 8b provided in second electronic component 8. Thus, solder particles 5a and 7a are melted by heating. Terminal parts 6b and metal bumps 8b are solder-bonded to land part 3a and land part 3b, respectively.

That is to say, in first electronic component 6, molten solder in which solder particles 5a are melted wets the surfaces of land parts 3a and terminal parts 6b. Thus, as shown in an enlarged view in a circle, solder bonding part 5c in a form of solder fillet is formed. Furthermore, in second electronic component 8, the molten solder in which solder particles 7a are melted spreads between metal bump 8b and land part 3b, and solder bonding part 7c for bonding bump 8b and land part 3b to each other is formed.

Thermosetting resin 5b and thermosetting resin 7b constituting first bonding material 5 and second bonding material 7 are thermally cured by heating along with the solder bonding. Thus, a gap at the lower surface side of first electronic component 6 is sealed and resin part 5d that covers solder bonding part 5c is formed. Furthermore, a gap at the lower surface side of second electronic component 8 is sealed and resin part 7d that covers solder bonding part 7c is formed. The reactions by heating proceed concurrently. Thereby, resin in prepreg 10 is fused to the interfaces of resin parts 5d and 7d. Then, in upper surface 2a of resin substrate 2, sealing resin layer 10b that seals first electronic component 6, second electronic component 8, resin parts 5d and 7d, and wiring pattern 3 is formed.

In the pressing step, prepreg 10 as a thermosetting sheet for forming sealing resin layer 10b, which seals first electronic component 6, second electronic component 8 and wiring patterns 3 formed on the periphery thereof, is attached to upper surface 2a of base wiring layer 1 after the bonding material temporary curing step, and is subjected to thermo-compression bonding. Thus, curing of prepreg 10, curing of first bonding material 5, curing of second bonding material 7, solder bonding of terminal part 6b to land part 3a, and solder bonding of metal bump 8b to land part 3b are carried out concurrently. Then, the thus formed sealing resin layer 10b is brought into close contact with upper surface 2a of base wiring layer 1 as well as main body parts 6a and 8a of electronic components 6 and 8. At this time, as mentioned above, the deformation amount of base wiring layer 1 is in the range of the permissible deformation amount so that failure is not induced in the subsequent steps. Therefore, displacement of first electronic component 6 and second electronic component 8 caused by the deformation of base wiring layer 1 and failure such as break in the solder bonding part do not occur.

Next, as shown in FIG. 3C, a plated layer is formed on the inner surface of through hole 17a penetrating laminated body 17. Thus, interlayer wiring part 18 for connecting wiring pattern 3 of base wiring layer 1 to copper foils 13 and 16 of wiring layers 11 and 14 is formed (interlayer wiring step). Furthermore, by providing patterning on copper foils 13 and 16 of wiring layers 11 and 14, wiring circuits 13a and 16a are formed (circuit formation step). As mentioned above, electronic component module 19 is completed.

That is to say, electronic component module 19 includes base wiring layer 1 on which wiring pattern 3 is formed on the upper surface thereof. Wiring pattern has land parts 3a and 3b to which electronic components are to be connected. Furthermore, in electronic component module 19, first electronic component 6 including main body part 6a and terminal part 6b as well as second electronic component 8 including main body part 8a and metal bump 8b are installed on base wiring layer 1 in a state in which terminal parts 6b and metal bumps 8b are connected to land parts 3a and 3b, respectively. Furthermore, in electronic component module 19, first electronic component 6, second electronic component 8 and wiring pattern 3 provided on the periphery thereof are sealed by sealing resin layer 10b formed in close contact with upper surface 2a of base wiring layer 1 and main body parts 6a and 8a. The thus manufactured electronic component module 19 further serves as a subject to which a component is to be mounted. Electronic components are mounted on wiring layer 11 on the surface layer and on wiring layer 14 on the lower surface layer if necessary. Thus, a mount board is completed.

This exemplary embodiment shows an example in which two types of electronic components, that is, first electronic component 6 such as a chip-type small component and second electronic component 8 such as a flip chip are mounted on base wiring layer 1 respectively via the first bonding material disposing step, the first electronic component holding step, a second bonding material disposing step and the second electronic component holding step. However, only one type of electronic component may be mounted on base wiring layer 1.

Furthermore, in the above-mentioned exemplary embodiment, the bonding material temporary curing step is carried out with respect to first electronic component 6 and second electronic component 8 concurrently after they are both placed. However, this step may be carried out with respect to first electronic component 6 and second electronic component 8 individually by different heating methods. For example, first electronic component 6 is placed on base wiring layer 1, and then heating for temporarily curing first bonding material 5 is carried out by allowing base wiring layer 1 to be accommodated in a curing device. Furthermore, second electronic component 8 may be held by base wiring layer 1 by using a placement head, and when the component is placed, second bonding material 7 may be heated by a heat source equipped with the placement head via second electronic component 8.

### INDUSTRIAL APPLICABILITY

The present invention has an advantage that bonding reliability can be secured by suppressing warp deformation of a base wiring layer, and therefore is useful in a field of manufacturing an electronic component module formed by laminating a plurality of wiring layers.

1. A method for manufacturing an electronic component module, the electronic component module comprising a base wiring layer having, on an upper surface thereof, a wiring pattern including a land part to which an electronic component is to be connected; an electronic component including a main body part and a terminal part, the electronic component being installed on the base wiring layer in a state in which the terminal part is connected to the land part; and a sealing resin layer that is formed in close contact with the upper surface of the base wiring layer and the main body part and seals the electronic component and the wiring pattern,
the method comprising:
disposing a bonding material made of thermosetting resin containing solder particles in a region that covers at least the land part on the upper surface of the base wiring layer;
positioning the terminal part with respect to the land part and adhesively bonding at least the terminal part to the bonding material that covers the land part, thereby holding the electronic component by the base wiring layer;
after the holding of the electronic component, semi-curing the bonding material by heating; and
after the semi-curing of the bonding material, thermo-compression bonding a thermosetting sheet for forming the sealing resin layer in a state in which the thermosetting sheet is attached to an upper surface of the base wiring layer, thereby curing the thermosetting sheet, curing the bonding material, and solder-boding the terminal part to the land part.

2. The method for manufacturing an electronic component module of claim 1,
wherein in the semi-curing of the bonding material, the bonding material is semi-cured in a heating condition in which warp deformation due to heating of the base wiring layer is not beyond a predetermined permissible amount.

3. The method for manufacturing an electronic component module of claim 1,
wherein in the disposing of the bonding material, the bonding material is further disposed in a region corresponding to the main body part of the electronic component.

4. The method for manufacturing an electronic component module of claim 1,
wherein in the semi-curing of the bonding material, the bonding material is heated to a temperature that is not beyond a melting point temperature of the solder particles.
